(19) United States
(12) Patent Application Publication
(10) Pub. No.: US 2012/0314979 A1
(43) Pub. Date: Dec. 13, 2012

(54) Bag and a Method of Manufacturing a Bag

(75) Inventor: Heine Heininga, Hinsdale, IL (US)

(73) Assignee: Polytex Fibers Corporation, Houston, TX (US)

(21) Appl. No.: 13/441,358

(22) Filed: Apr. 6, 2012

Related U.S. Application Data
(60) Provisional application No. 61/516,889, filed on Apr. 11, 2011.

(51) Int. Cl. B65D 33/16; B65D 30/04; B65D 30/10; B31B 1/66; B31B 1/60; B31B 1/62; B31B 1/64; B65D 30/02; B65D 33/28

(52) U.S. Cl. 383/200; 383/42; 383/211; 383/63; 383/64; 493/214; 493/192; 493/189

(57) ABSTRACT

The present disclosure provides a bag with one or more easy open features, which in certain embodiments are reclosable. Methods of making such bags are also disclosed.

### CROSS-REFERENCE TO RELATED APPLICATION

This application claims the benefit of U.S. Provisional Patent Application Ser. No. 61/516,889, filed on Apr. 11, 2011, which is incorporated herein by reference in its entirety.

### STATEMENT REGARDING FEDERALLY SPONSORED RESEARCH OR DEVELOPMENT

Not Applicable.

### THE NAMES OF THE PARTIES TO A JOINT RESEARCH AGREEMENT

Not Applicable.

### INCORPORATION-BY-REFERENCE OF MATERIAL SUBMITTED ON A COMPACT DISC

Not Applicable.

### FIELD OF THE INVENTION

The invention relates to bags with one or more easy open features and methods of making a bag with one or more easy open features, and further relates to plastic bags with one or more easy open features and methods for manufacturing the same.

### BACKGROUND

Bags have been made with a variety of different materials and have found use in a wide variety of applications. Similarly, reclosable and/or resealable bags are useful in a variety of applications. Conventional plastic bags use a number of different features to allow the bags to be reclosable and/or resealable, with varying degrees of cost and difficulty associated with manufacturing such features. In addition, a bag should protect and preserve the contents of the bag without making it too difficult to open the bag.

Certain types of plastic bags have provided improvements in sealing the ends of the bags. For example, in U.S. Pat. No. 6,800,051 B2 (“the '051 patent”), issued on Oct. 5, 2004, a process for sealing side fold sacks made of plastic film is described. According to the '051 patent, a web of plastic tubular film is cut to provide a staggered detachment along a perforation so that one wall (e.g., the front wall) projects beyond the opposing wall (e.g., the back wall). The projecting portion of the first wall is then folded over and sealed to the opposing wall by means of a plastic adhesive such as a polyurethane adhesive or hot melt. The '051 patent is hereby incorporated by reference herein. However, such bags are unable to handle the weight loads of conventional bulk bags made of paper and other materials. Such bags are useful for only certain lightweight contents, such as bread.

U.S. Pat. No. 7,165,887 discloses a reclosable bag that is opened and closed by a zipper. Sides of the bag form a continuous loop that covers the entire zipper including a slide actuator of the zipper. The loop is formed from sides of the bag itself, and not from a separate sheet. The loop is removed by tearing along perforated weakened areas of the loop. Due to the perforated weakened areas, the loop is weakened and is unable to reinforce the holding power of the zipper to prevent accidental opening of the zipper. Moreover, the cover completely covers the zipper including the slide actuator, which conceals the zipper from inspection to detect tampering.

U.S. Pat. No. 7,237,953 discloses a bag that is opened and closed by a zipper. Front and rear walls of the bag extend above the zipper and are bonded together. The cover is arranged loosely over the zipper, such that the cover is unable to reinforce the holding power of the zipper. The cover over the entire zipper conceals the zipper from inspection to detect tampering. Such tampering can be performed by cutting through the cover easily and cleanly with a sharp tool to gain access to the zipper and the interior of the bag. Following tampering, the damage to the cover can be repaired by applying glue to conceal that the cover was cut. The repaired cover falsely appears to be wholly intact and untampered with. The repaired cover conceals the entire zipper including the slide actuator from inspection to detect tampering.

U.S. Pat. No. 4,008,850 provides an early description of a bag of tubular form having a stepped end, and further having a front surface and a rear surface adapted to overlap the front surface, between which gussets are interposed, and a stepped end of said tube is closed by being folded against said front surface and adherently secured in position. The adherence of the stepped end would need to be broken in order to open the bag, which prevents resealing the stepped end. It would be desirable to provide a zipper for closing the stepped end. Further it would be desirable to provide a method for assembling a zipper to a stepped end of a tube that is made into a bag.

United States Patent Application Publication No. 2008/0047228 A1 discloses a bag having a reclosable zipper at one end, and the zipper provides a peel seal and a hard seal, which enable the zipper to resist forces resulting from dropping a filled bag. However, a need exists to provide a bag with a stepped end and to combine the stepped end with a zipper. Further it would be desirable to isolate the zipper from forces endured by the bag, which result from dropping the bag, or rough handling of the bag, while filled with contents. Further it would be desirable to provide a method for making the bag with a stepped end combined with a zipper wherein the zipper is isolated from forces resulting from dropping the bag while filled with contents.

### SUMMARY OF THE DISCLOSURE

The present disclosure provides a bag with an easy open feature, which in certain embodiments is reclosable. In addition, methods of making such bags are disclosed.

The present disclosure provides a bag having a top, a bottom, a first side and a second side, comprising a first panel having a top, a bottom, a first side, a second side, a first surface and a second surface, a first side panel having a top, a bottom, a first side, a second side, a first surface and a second surface, the first side of the first side panel attached to the second side of the first panel, a second panel having a top, a bottom, a first side, a second side, a first surface and a second surface, the first side of the second panel attached to the second side of the first side panel, a second side panel having a top, a bottom, a first side, a second side, a first surface and a second surface, the first side of the second side panel attached to the second side of the second panel and the second side of the second side panel attached to the first side of the first panel, the first panel, first side panel, second panel and second side panel defining a first opening proximal to the top of the front panel and a second opening proximal to the bottom of the front panel, and an easy open feature attached to the first surface of the first panel proximal to the top of the first panel. The top of the second panel can also comprise a tab located anywhere along the top of the second panel, including, but not limited to, at about the midpoint or center of the top of the second panel. In certain embodiments the first side panel and/or the second side panel comprises a gusset or fold having a top and a bottom. In certain embodiments, the top of the second panel extends further than the top of the first panel. The top of the gusset of the first side panel and/or the top of the gusset of the second side panel can be stepped. In such embodiments the portion of the gusset nearest to the first panel extends further than the first panel, the portion of the gusset nearest to the second panel extends further than the portion of the gusset nearest to the first panel but not as far as the second panel. Additionally, the bottom of the gusset of the first side panel and/or the bottom of the gusset of the second side panel can be stepped. The easy open feature can also be attached to the second surface of the second panel proximal to the top of the second panel, and in certain embodiments the top of the bag can be folded over twice before attachment of the second surface of the second panel to the easy open feature. In particular embodiments the easy open feature covers at least a portion of the first opening. In further embodiments the second end of the first panel, first side panel, second panel and second side panel are sealed.

In certain embodiments the easy open feature comprises a first elongated member having a first end and a second end. The first elongated member can be a co-extruded layer, comprise a polymeric film, including, but not limited to, polypropylene, polyethylene, polyethylene terephthalate, polystyrene, polyamide, or any combination thereof, comprise an oriented polymeric film, including, but not limited to, oriented polypropylene, biaxially-oriented polypropylene, oriented polyethylene, biaxially-oriented polyethylene, oriented polyethylene terephthalate, biaxially-oriented polyethylene terephthalate, oriented polyamide, biaxially-oriented polyamide, or any combination thereof, comprise a metalized polymeric film or comprise paper, such as a coated paper. At least a portion of the easy open feature or the bag may be suitable for having high quality print graphics thereon.

In further embodiments the easy open feature further comprises a second elongated member having a first end and a second end. The first elongated member and the second elongated member can be co-extruded layers, comprise a polymeric film, including, but not limited to, polypropylene, polyethylene, polyethylene terephthalate, polystyrene, polyamide, or any combination thereof, comprise an oriented polymeric film, including, but not limited to, oriented polypropylene, biaxially-oriented polypropylene, oriented polyethylene, biaxially-oriented polyethylene, oriented polyethylene terephthalate, biaxially-oriented polyethylene terephthalate, oriented polyamide, biaxially-oriented polyamide, or any combination thereof, comprise a metalized polymeric film or comprise paper. The first elongated member or the second elongated member can comprise a perforated pull strip. The perforations can be made, for example, by a laser or mechanical means. In alternative embodiments the first elongated member and the second elongated member comprises a polymer, including, but not limited to, polypropylene, high density polyethylene, low density polyethylene, polyester, or any combination thereof. The polymer can also be woven. In certain embodiments the first elongated member comprises a different material than the second elongated member.

The first elongated member and/or the second elongated member can comprise a sealing feature, such as an adhesive. Adhesives that can be utilized include, but are not limited to, animal glues, starches, water-based or solvent-based hot melts such as polyurethane, polyamide, polyethylene, ethylene/vinyl acetate, or any other suitable monomeric or polymeric adhesive or sealing material. The easy open feature can comprise a sliding actuator between the first elongated member and the second elongated member, which in certain embodiments is inverted, and can further comprise a mechanical stop located proximal the first end or the second end of the first elongated member and the second elongated member, or a first mechanical stop and a second mechanical stop, wherein the first mechanical stop is located proximal the first end of the first elongated member and the second elongated member and the second mechanical stop is located proximal the second end of the first elongated member and the second elongated member. Additionally the first elongated member and the second elongated member can comprise a closable or track interlock feature. Easy open features comprising one or more closable or track interlock features are termed “reclosable” easy open features.

The first panel, first side panel, second panel and second side panel can be comprised of a polymer, including, but not limited to, polypropylene, high density polyethylene, low density polyethylene, polyester, or any combination thereof, or a woven polymer. Furthermore, the first panel, first side panel, second panel and second side panel can be comprised of a continuous piece of polymeric material, or alternatively can be discontinuous, meaning that there can be one or more seams. Seams are generally located on the back panel, but can also be on the front panel, first side panel and/or second side panel. The continuous (or discontinuous) piece of polymeric material can further include a second layer of non-woven material, including, but not limited to, a polymeric film, oriented polymeric film or paper. Additionally the continuous (or discontinuous) piece of polymeric material can further include a third layer of non-woven material, including, but not limited to, a polymeric film, oriented polymeric film or paper.

The present disclosure also provides a bag having a top and a bottom, comprising a first panel having a top, a bottom, a first side, a second side, a first surface and a second surface, a second panel having a top, a bottom, a first side, a second side, a first surface and a second surface, the first side of the second panel attached to the second side of the first panel, and the second side of the second panel attached to the first side of the first panel, the first panel and the second panel defining a first opening proximal to the top of the front panel and a second opening proximal to the bottom of the front panel, and an easy open feature attached to the first surface of the first panel proximal to the top of the first panel. In certain embodiments the top of the second panel extends further than the top of the first panel. The top of the second panel can comprise at least a first tab located anywhere along the top of the second panel, for example at about the midpoint of the top of the second panel. In certain embodiments the easy open feature covers at least a portion of the first opening.

The present disclosure additionally provides a method of making a bag having a top, a bottom, a first side and a second side, comprising preparing a bag comprising a first panel having a top, a bottom, a first side, a second side, a first surface and a second surface, a first side panel having a top, a bottom, a first side, a second side, a first surface and a second surface, the first side of the first side panel attached to the second side of the first panel, a second panel having a top, a bottom, a first side, a second side, a first surface and a second surface, the first side of the second panel attached to the second side of the first side panel, and a second side panel having a top, a bottom, a first side, a second side, a first surface and a second surface, the first side of the second side panel attached to the second side of the second panel and the second side of the second side panel attached to the first side of the first panel, and the first panel, first side panel, second panel and second side panel defining a first opening proximal to the top of the front panel and a second opening proximal to the bottom of the front panel, and attaching an easy open feature to the first surface of the first panel proximal to the top of the first panel. Either the top or the bottom of the bag can be sealed. An exemplary way of sealing the top of the bag is by attaching the second surface of the second panel proximal to the top of the second panel to the easy open feature. In particular embodiments the top of the bag can be folded over twice before attachment of the second surface of the second panel to the easy open feature. In certain embodiments the top of the second panel extends further than the top of the first panel. The bag can be initially prepared with the top of the second panel extending further than the top of the first panel, or alternatively the bag can be initially prepared with the top of the second panel and the top of the first panel extending the same distance, and thereafter a portion of the top of the first panel is folded down to contact the first surface of the first panel, or the bag can be initially prepared with the top of the second panel and the top of the first panel extending the same distance, and thereafter a portion of the top of the first panel is removed. Slits can be cut into the sides of the top of the bag to allow a portion of the top of the front panel to be folded down or removed. The easy open feature can be attached to the first surface of the first panel and the second surface of the second panel using an adhesive, heat, hot air, pressure, ultrasonic energy or any combination thereof, and can be attached to the first surface of the first panel and the second surface of the second panel simultaneously.

The present disclosure further provides a method of making a bag having a top and a bottom, comprising preparing a bag comprising a first panel having a top, a bottom, a first side, a second side, a first surface and a second surface, and a second panel having a top, a bottom, a first side, a second side, a first surface and a second surface, the first side of the second panel attached to the second side of the first panel, and the second side of the second panel attached to the first side of the first panel, and the first panel and the second panel defining a first opening proximal to the top of the front panel and a second opening proximal to the bottom of the front panel, and attaching an easy open feature to the first surface of the first panel proximal to the top of the first panel. Either the top or the bottom of the bag can be sealed. An exemplary way of sealing the top of the bag is by attaching the second surface of the second panel proximal to the top of the second panel to the easy open feature. In particular embodiments the top of the bag can be folded over twice before attachment of the second surface of the second panel to the easy open feature. The top of the second panel can extend further than the top of the first panel. Once again the bag can be initially prepared with the top of the second panel extending further than the top of the first panel, or alternatively the bag can be initially prepared with the top of the second panel and the top of the first panel extending the same distance, and thereafter a portion of the top of the first panel is folded down to contact the first surface of the first panel, or the bag can be initially prepared with the top of the second panel and the top of the first panel extending the same distance, and thereafter a portion of the top of the first panel is removed. Slits can be cut into the sides of the top of the bag to allow a portion of the top of the front panel to be folded down or removed. The easy open feature can be attached to the first surface of the first panel and the second surface of the second panel using an adhesive, heat, hot air, pressure, ultrasonic energy or any combination thereof, and can be attached to the first surface of the first panel and the second surface of the second panel simultaneously.

### BRIEF DESCRIPTION OF THE DRAWINGS

The following drawings form part of the present specification and are included to further demonstrate certain aspects of the present disclosure. The disclosure may be better understood by reference to one or more of these drawings in combination with the detailed description of specific embodiments presented herein.

FIG. 1. A front view of an embodiment of a bag of the present disclosure.

FIG. 2A. A side view of an embodiment of a bag of the present disclosure including an embodiment of an easy open feature.

FIG. 2B. A side view of an embodiment of a bag of the present disclosure including an embodiment of an easy open feature, with the top of the bag folded over twice before attachment to the easy open feature.

FIG. 3. A perspective view of an embodiment of an easy open feature.

FIG. 4. A perspective view of one end of another embodiment of an easy open feature having sealing features.

FIG. 5. A perspective view of one end of another embodiment of an easy open feature.

FIG. 6. A perspective view of one end of another embodiment of an easy open feature.

FIG. 7. A perspective view of one end of another embodiment of an easy open feature.

FIG. 8. A perspective view of one end of another embodiment of an easy open feature.

FIG. 9. A perspective view of one end of an embodiment of a reclosable easy open feature, showing the sealing features and the track interlock features.

FIG. 10. A front view of an embodiment of a bag of the present disclosure with a cut-out showing an inner woven layer.

FIG. 11. A front view of an embodiment of a bag of the present disclosure with an embodiment of an easy open feature attached to the first panel of the bag.

FIG. 12. A front view of the bag shown in FIG. 11 with the second panel of the bag folded over and attached to the easy open feature.

FIG. 13. A front view of an embodiment of a bag of the present disclosure with the second panel of the bag folded over and attached to the easy open feature shown in FIG. 9.

FIG. 14. A front view of an embodiment of a bag of the present disclosure with the second panel of the bag folded over and attached to an easy open feature comprising a sliding actuator.

FIG. 15. A front view of an embodiment of a bag of the present disclosure with a cut-out showing an inner woven layer and with an embodiment of an easy open feature attached to the first panel of the bag and covering the first opening.

FIG. 16. A front view of an alternative embodiment of a bag of the present disclosure having no side panels.

FIG. 17. A front view of the bag shown in FIG. 16 with an easy open feature attached to the first panel of the bag and covering the first opening.

### DETAILED DESCRIPTION

FIG. 1 shows a bag 100, which comprises a first panel 102 having a first end 102a (not visible in FIG. 1), a second end 102b, a first side 102c, a second side 102d, an outer surface 102e and an inner surface 102f (not visible in FIG. 1), a second panel 104 having a first end 104a, a second end 104b, a first side 104c (not visible in FIG. 1), a second side 104d, an outer surface 104e, and an inner surface 104f (not visible in FIG. 1), a first side panel 106 (not visible in FIG. 1) having a first end 106a (not visible in FIG. 1), a second end 106b (not visible in FIG. 1), a first side 106c (not visible in FIG. 1), a second side 106d (not visible in FIG. 1), an outer surface 106e (not visible in FIG. 1) and an inner surface 106e (not visible in FIG. 1), and a second side panel 108 having a first end 108a (not visible in FIG. 1), a second end 108b, a first side 108c (not visible in FIG. 1), a second side 108d (not visible in FIG. 1), an outer surface 108e (not visible in FIG. 1) and an inner surface 108f (not visible in FIG. 1), and an easy open feature 120 (not visible in FIG. 1). The first end 104a of the second panel 104 extends beyond the first end 102a (not visible in FIG. 1) of the first panel 102, the first end 106a (not visible in FIG. 1) of side panel 106 (not visible in FIG. 1), and the first end 108a (not visible in FIG. 1) of side panel 108, thus creating a hood or flap region 132 comprising a tab portion 132a. The first and second side panels 106 and 108 are also referred to as first and second side gussets 106 and 108. The first side panel 106 (not visible in FIG. 1) and second side panel 108 can be folded flat, such that the bag 100 is folded flat for shipment and handling. The second end 102b of first panel 102, second end 104b of second panel 104, second end 106a (not visible in FIG. 1) of second side panel 106 (not visible in FIG. 1), and second end 108b of second side panel 108 of bag 100 define an elongated opening 110 through which contents can be received to fill the bag 100. After the bag 100 has been filled with contents, the opening 110 can be closed, for example, by sewing, sealing, using an adhesive or adhesive tape, by pinch closing, followed by folding on itself, and then sealing, or any combination thereof.

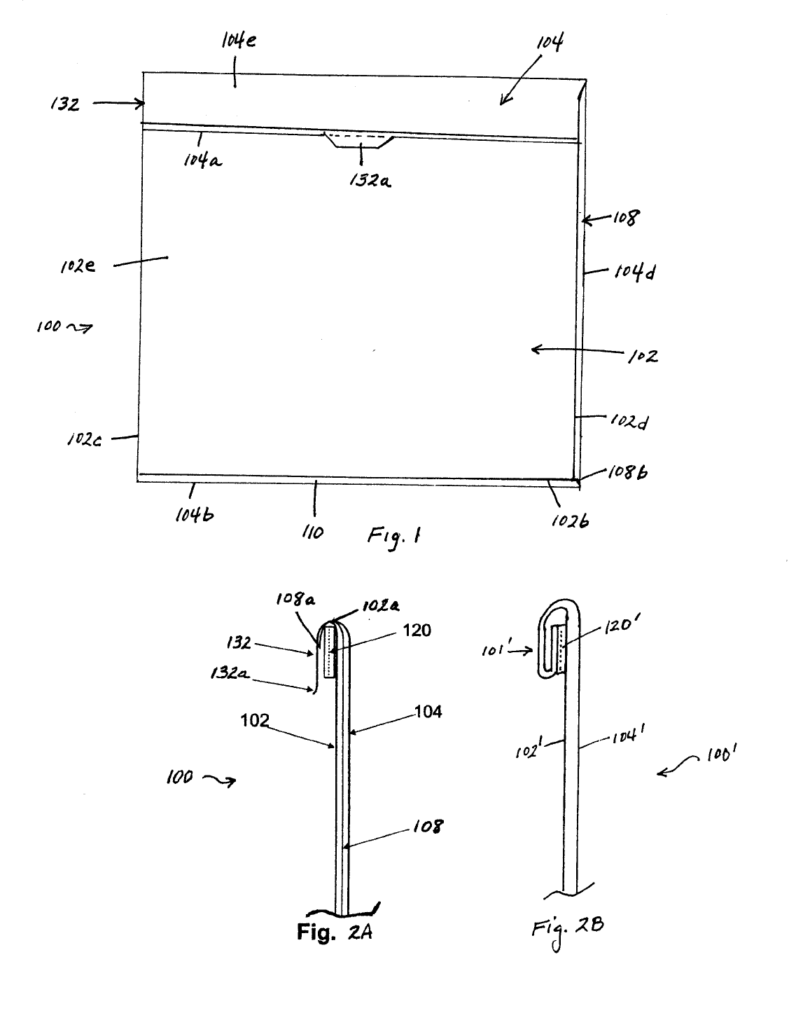

Referring now to FIG. 2A, a side view of a portion of bag 100 is shown. Like features and elements in the drawings have the same numerals in the various figures. Bag 100 once again comprises first panel 102, second panel 104 having hood or flap region 132 and tab portion 132a, and side panel 108. However, in FIG. 2A the first end 102a of the first panel 102, the first end 108a of the second side panel 108, and the easy open assembly 120 are now visible.

Referring now to FIG. 2B, a side view of a portion of a “flush cut” bag 100′ is shown. Bag 100′ comprises a top end 101′, a first panel 102′ and second panel 104′ of equal lengths (hence “flush cut”), and an easy open assembly 120′. As shown in FIG. 2B the top end 101′ of the bag 100′ is folded over twice before attachment to the easy open assembly 120. In other embodiments (not shown), the top end of a bag with the second panel extending further than the first panel can be folded over twice before attachment to the easy open device.

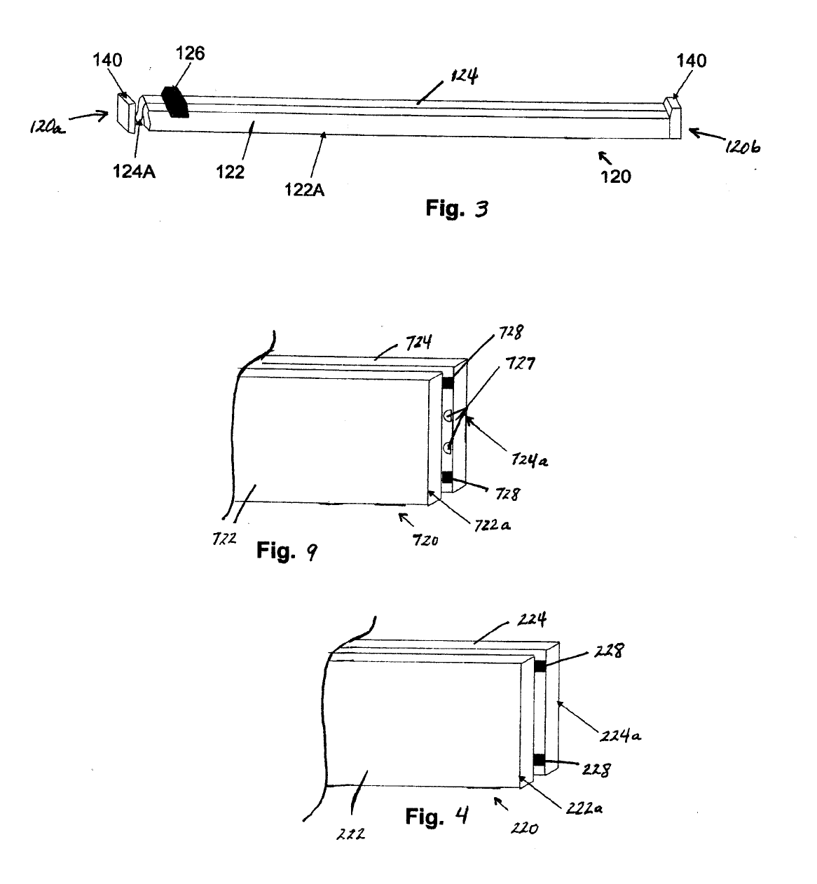

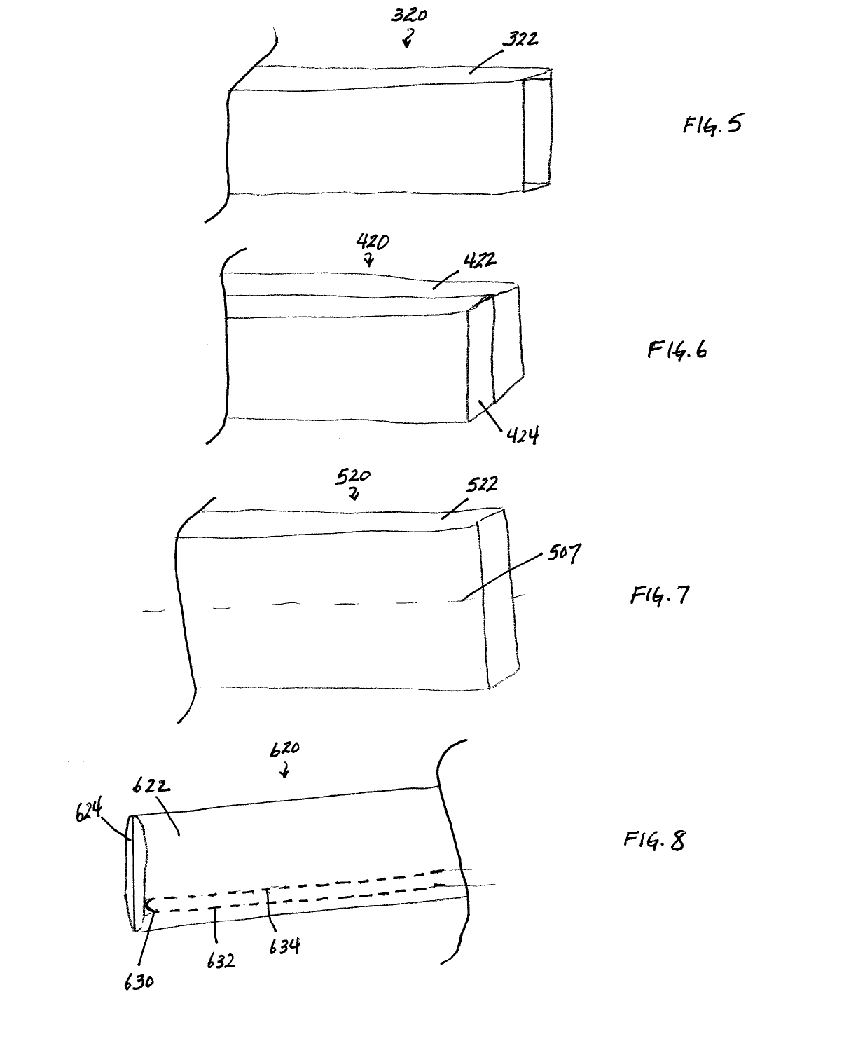

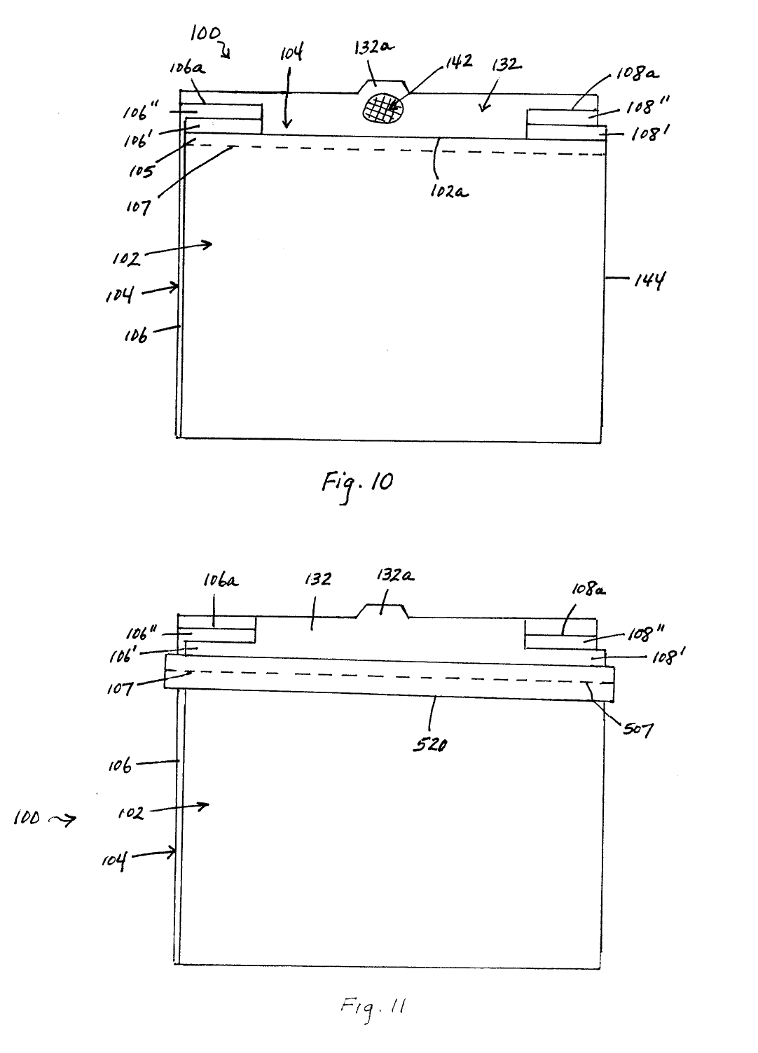

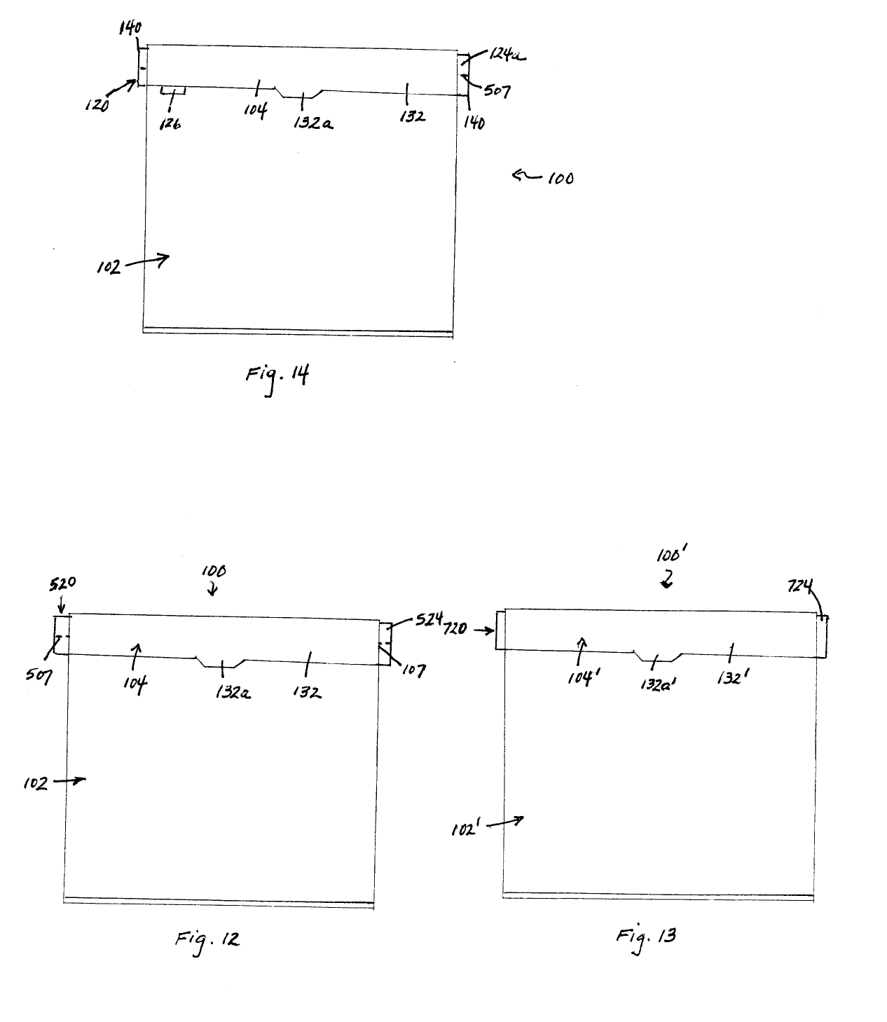

Referring now to FIG. 3, an embodiment of an easy open or zipper assembly 120 is shown. Easy open assembly 120 comprises a first elongated fastening member 122 and a second elongated fastening member 124 that releasably interlock by displacement of a sliding actuator 126 over the first and second fastening members 122 and 124. As shown in FIG. 3, the sliding actuator 126 is located proximal to the first end 120a of the easy open assembly 120 when in a closed position, although in other embodiments (not shown) the sliding actuator 126 can be located proximal to the second end 120b of the easy open assembly 120 in a closed position, or inverted and located proximal to the first end 120a or second end 120b when in a closed position. Sliding the actuator 126 across the first and second fastening members 122 and 124 will unlock the first fastening member 122 and the second fastening member 124 from each other, which allows separation of the first and second fastening members 122 and 124 to provide access to a bag (not shown). Sliding the actuator 126 across the first and second fastening members 122 and 124 in the opposite direction will releasably attach the first fastening member 122 and the second fastening member 124 to each other. Also shown in FIG. 3 are end seals 140, which seal a crevice between the ends of the first and second fastening members 122 and 124 and also provide a mechanical stop at each end of the first and second fastening members 122 and 124 to limit sliding displacement of the actuator 126 along the first and second fastening members 122 and 124. In FIG. 3 the elongated first fastening member 122 has an elongated flange 122a and the elongated second fastening member 124 has an elongated flange 124a. The flanges 122a and 124a typically comprise low density molecular weight polyethylene (LDPE) or polypropylene (PP).

Referring now to FIG. 4, another embodiment of an easy open assembly 220 is shown. Easy open assembly 220 comprises a first elongated fastening member 222 and a second elongated fastening member 224 that releasably interlock by opening the sealing features 228 embedded in the fastening members 222 (not visible in FIGS. 4) and 224. Opening the sealing features 228 from either end or from the middle of assembly 220 will unlock the first and second elongated fastening members 222 and 224 from each other, which allows separation of the first and second elongated fastening members 222 and 224 to provide access to a bag (not shown). The first and second elongated fastening members 222 and 224 comprise flanges 222a and 224a, which typically comprise LDPE or PP.

Referring now to FIG. 5, another embodiment of an easy open assembly 320 is shown. Easy open assembly 320 comprises an elongated member 322 that is co-extruded or comprised of a film, including, but not limited to, polyethylene (PE), polypropylene (PP), polystyrene (PS), polyamide (PA), nylon, or any combination thereof, or paper, and can alternatively have an adhesive on one or both sides. Elongated member 322 is susceptible to tearing form either direction or in the middle, which will provide access to a bag (not shown).

Referring now to FIG. 6, another embodiment of an easy open assembly 420 is shown. Easy open assembly 420 comprises a first elongated member 422 and a second elongated member 424, each of which is comprised of a film, including, but not limited to, polyethylene (PE), polypropylene (PP), polystyrene (PS), polyamide (PA) or any combination thereof, or paper. First elongated member 422 and second elongated member 424 can each comprise the same film or paper, or a different film or paper. First elongated member 422 and second elongated member 424 are each susceptible to tearing form either direction or in the middle, which will provide access to a bag (not shown).

Referring now to FIG. 7, another embodiment of an easy open assembly 520 is shown. Easy open assembly 520 comprises an elongated member 522 comprised of a film, including, but not limited to, polyethylene (PE), polypropylene (PP), polystyrene (PS), polyamide (PA) or any combination thereof, or paper. Elongated member 522 also comprises a fold line 507, which can be utilized when closing or sealing the end of a bag (not shown) proximal to the easy open assembly 520. Elongated member 522 is susceptible to tearing form either direction or in the middle, which will provide access to a bag (not shown).

Referring now to FIG. 8, another embodiment of an easy open assembly 620 is shown. Easy open assembly 620 comprises an elongated member 622 comprised of a polymer or woven polymer, including, but not limited to polypropylene, high density polyethylene, low density polyethylene, polyester, or any combination thereof film, including, but not limited to, polyethylene, polypropylene, polystyrene, polyamide or any combination thereof, or paper. Elongated member 622 also comprises a cut 630 and a first row of perforations 632 and a second row of perforations 634. Pulling on cut 630 will tear open the first row of perforations 632 and the second row of perforations 634, which will provide access to a bag (not shown).

Referring now to FIG. 9, an embodiment of a reclosable easy open assembly 720 is shown. Reclosable easy open assembly 720 comprises a first elongated fastening member 722 and a second elongated fastening member 724 that releasably interlock by opening the sealing features 728 and the reclosable track interlock features 727 imbedded in the first and second elongated fastening members 722 and 724. Opening the sealing features 728 and the reclosable track interlock features 727 from either direction or in the middle will unlock the first elongated fastening member 722 and the second elongated fastening member 724 from each other, which allows separation of the first and second elongated fastening members 722 and 724 to provide access to a bag (not shown). Reclosing is accomplished by applying pressure along the reclosable track interlock features 727, for example by pressing them together (e.g., a “press to close” feature). The first and second elongated fastening members 722 and 724 comprise flanges 722a and 724a, which typically comprise LDPE or PP.

Referring now to FIG. 10, an embodiment of a bag 100 is shown. Bag 100 comprises a first panel 102, a second panel 104 having hood or flap region 132 and tab portion 132a, a first side panel 106 having a first end 106a, and a second side panel 108 (not visible in FIG. 10) having a first end 108a. As shown in FIG. 10, bag 100 comprises an interior woven layer 142 (visible through cut-out), for example, a woven PP layer, and an exterior layer 144, such as a polymeric film or paper. The exterior polymeric non-woven layer 144 can alternatively comprise a single polymer layer, or a laminated composite of two or more non-woven polymer layers. A composite exterior layer 144 can have an inner sheet or film facing toward the woven layer 142, and an outer sheet or film facing away from the woven layer 142. The woven layer 142 can be woven as seamless tube or as a flat sheet, and each sheet or film for the outer layer 144 can be formed into a seamless tube or with seams to make a seamed tube. As shown in FIG. 10, the first side panel 106 comprises a gusset having a first portion 106′ connected by a fold to a second portion 106″. Similarly, the second side panel 108 comprises a gusset having a first portion 108′ connected by a fold to a second portion 108″. In the embodiment of the bag 100 shown in FIG. 10, the second portions 106″ and 108″ extend past the first portions 106′ and 108′, which in turn extend past the first end 102a of the first panel 102 (this configuration is also called a stepped end). However, in alternate embodiments (not shown), the second portions 106″ and 108″ have the same length as the first portions 106′ and 108′. Also shown is line 107, which is a reference line that demarcates a portion 105 of the first panel 102 that is separate from the remainder of the first panel 102. The line 107 can also comprise a fold line (not shown).

Referring now to FIG. 11, the bag 100 depicted in FIG. 10 is shown with an embodiment of an easy open assembly 220 attached. Bag 100 again comprises a first panel 102, a second panel 104 having hood or flap region 132 and tab portion 132a, a first side panel 106 comprising a gusset having a first portion 106′ connected by a fold to a second portion 106″ and having a first end 106a, and a second side panel 108 (not visible in FIG. 11) comprising a gusset having a first portion 108′ connected by a fold to a second portion 108″ and having a first end 108a. Once again in the embodiment of the bag 100 shown in FIG. 11, the second portions 106″ and 108″ extend past the first portions 106′ and 108′, which in turn extend past the first end 102a (not visible in FIG. 7) of the first panel 102. Bag 100 also comprises easy open assembly 520, which comprises an elongated member 522 and line 507, which is located directly above line 107 of bag 100. In other embodiments (not shown), bag 100 can comprise the easy open assembly 120, 220, 320, 420, 620 or the reclosable easy open assembly 720.

A number of methods can be used to attach an easy open assembly 120 (or 220, 320, 420, 520 or 620) or reclosable easy open assembly 720 to bag 100 and subsequently seal the bag 100. For example, the easy open/reclosable easy open assembly (120, 220, 320, 420, 520, 620 or 720) is inverted, and the inverted flange 122a (or 222a or 722a, or elongated member 322, 424, 522 or 622) is placed in contact against the first panel 102 of the bag 100. In one embodiment the edge of the inverted flange 122 (or 222a or 722a, or elongated member 322, 424, 522 or 622) is placed in registration with the first end 102a of the first panel 102 of the bag 100, while in an alternative embodiment, the edge of the inverted flange 122 (or 222a or 722a, or elongated member 322, 424, 522 or 622) is placed in registration with line 107, leaving a gap between the edge of the inverted flange 122 (or 222a or 722a, or elongated member 322, 424, 522 or 622) and the first end 102a of the first panel 102 of the bag 100. When the line 107 is provided with a crease, the inverted flange 122a (or 222a or 722a, or elongated member 322, 424, 522 or 622) is in registration relative to the crease. The bag 100 can be foldable along the crease.

Once the inverted flange 122a (or 222a or 722a, or elongated member 322, 424, 522 or 622) is in contact with the first panel 102, an adhesive, heat, hot air, pressure, ultrasonic energy or any other sealing means, or any combination thereof, can be applied to seal the surfaces of the first panel 102 and the inverted flange 122a (or 222a or 722a, or elongated member 322, 424, 522 or 622) until the surfaces of the first panel 102 and the inverted flange 122a (or 222a or 722a, or elongated member 322, 424, 522 or 622) are heated to the heat activation temperature (the temperature at which the surfaces attain an adhesive state), or are otherwise sealed. This forms a seal between the first panel 102 and the inverted flange 122a (or 222a or 722a, or elongated member 322, 424, 522 or 622). Alternatively, an adhesive, heat, hot air, pressure, ultrasonic energy or any other sealing means, or any combination thereof, can be applied to form a seal between the flange 124a (or 224a or 724a, or elongated member 322, 422, 522 or 624) and the flap region 132 of the second panel 104, followed by folding over the bonded flange 124a (or 224a or 724a, or elongated member 322, 422, 522 or 624) and flap region, which inverts the easy open/reclosable easy open assembly 120 (or 220, 320, 420, 520, 620 or 720) and places the inverted flange 122a (or 222a or 722a, or elongated member 322, 424, 522 or 622) in contact against the first panel 102 of the bag 100. Then an adhesive, heat, hot air, pressure, ultrasonic energy or any other sealing means, or any combination thereof, is applied in order to form a seal between the first panel 102 and the inverted flange 122a (or 222a or 722a, or elongated member 322, 424, 522 or 622). Then again, in further embodiments the attachment of the easy open/reclosable easy open assembly 120 (or 220, 320, 420, 520, 620 or 720) and sealing the bag 100 can be accomplished by placing the inverted easy open/reclosable easy open assembly 120 (or 220, 320, 420, 520, 620 or 720) onto the first panel 102, folding the flap region 132 of the second panel 104 over the easy open/reclosable easy open assembly 120 (or 220, 320, 420, 520, 620 or 720), and then applying an adhesive, heat, hot air, pressure, ultrasonic energy or any other sealing means, or any combination thereof, to seal the surfaces of the flap portion 132 of the second panel 104, flange 124a (or 224a or 724a, or elongated member 322, 422, 522 or 624), flange 122a (or 222a or 722a, or elongated member 322, 424, 522 or 622), and the first panel 102, which are all in contact, forming a seal between the flap region 132 of the second panel 104 and the flange 124a (or 224a or 724a, or elongated member 322, 422, 522 or 624) and between the first panel 102 and flange 122a (or 222a or 722a, or elongated member 322, 424, 522 or 622).

Referring now to FIG. 12, the bag 100 depicted in FIG. 11 is shown with the hood or flap region 132 of the second panel 104 folded over the easy open assembly 520 to contact the elongated member 522. The tab portion 132a of the flap region 132 of the second panel 104 overhangs the first panel 102. In the embodiment shown in FIG. 12, the edge of elongated member 522 is placed in registration with the first end 102a (not visible in FIG. 8) of the first panel 102 of the bag 100, such that only flap region 132 of the second panel 104 is in contact with the elongated member 522 of the easy open feature 520. In an alternative embodiment wherein the edge of the elongated member 522 (or 322, 424 or 622, or inverted flange 122a, 222a or 722a) is placed in registration with line 107, which leaves a gap between the edge of the elongated member 522 (or 322, 424 or 622, or inverted flange 122, 222a or 722a) and the first end 102a of the first panel 102 of the bag 100, the flap region 132 of the second panel 104 and all or a portion of region 105 (see FIG. 10; not visible in FIG. 12) of the first panel 102 is in contact with the elongated member 522 of the easy open feature 520.

An exemplary way of sealing one end of the bag 100 as depicted in FIG. 8 is to apply an adhesive, heat, hot air, pressure, ultrasonic energy or any other sealing means, or any combination thereof, to the surface of the elongated member 522 and the surface of the hood or flap region 132 of the second panel 104, which are in contact, until the surface of the elongated member 522 and the surface of the flap region 132 of the second panel 104 are heated to the heat activation temperature (the temperature at which the surfaces attain an adhesive state) or are otherwise sealed. This forms a seal between the elongated member 522 and the flap region 132 of the second panel 104. This seals one end of the bag 100.

Referring now to FIG. 13, bag 100′ is shown with the hood or flap region 132′ of the second panel 104′ folded over the reclosable easy open assembly 720′ to contact the flange 724a. The tab portion 132a′ of the flap region 132′ of the second panel 104′ overhangs the first panel 102′. In the embodiment shown in FIG. 13, the edge of the inverted flange 722 (not visible in FIG. 13) is placed in registration with the first end 102a′ (not visible in FIG. 13) of the first panel 102′ of the bag 100′, such that only flap region 132′ of the second panel 104′ is in contact with the flange 724 of the reclosable easy open assembly 720. In an alternative embodiment wherein the edge of the inverted flange 722a (not visible in FIG. 9) is placed in registration with line 107 (see FIG. 12), which leaves a gap between the edge of the inverted flange 722a (not visible in FIG. 13) and the first end 102a′ of the first panel 102′ of the bag 100′, the flap region 132′ of the second panel 104′ and all or a portion of region 105′ (see FIG. 10; not visible in FIG. 13) of the first panel 102′ is in contact with the flange 724 of the reclosable easy open feature 720.

Referring now to FIG. 14, shown is a bag 100 similar to that depicted in FIG. 11, except that the hood or flap region 132 of the second panel 104 is folded over the easy open assembly 120 comprising sliding actuator 126 to contact the flange 124a. The tab portion 132a of the flap region 132 of the second panel 104 overhangs the first panel 102. In the embodiment shown in FIG. 14, the edge of the inverted flange 122 (not visible in FIG. 14) is placed in registration with the first end 102a (not visible in FIG. 14) of the first panel 102 of the bag 100, such that line 107 lies along the elongated center of easy open assembly 120 and only the flap region 132 of the second panel 104 is in contact with the flange 124a of the easy open assembly 120.

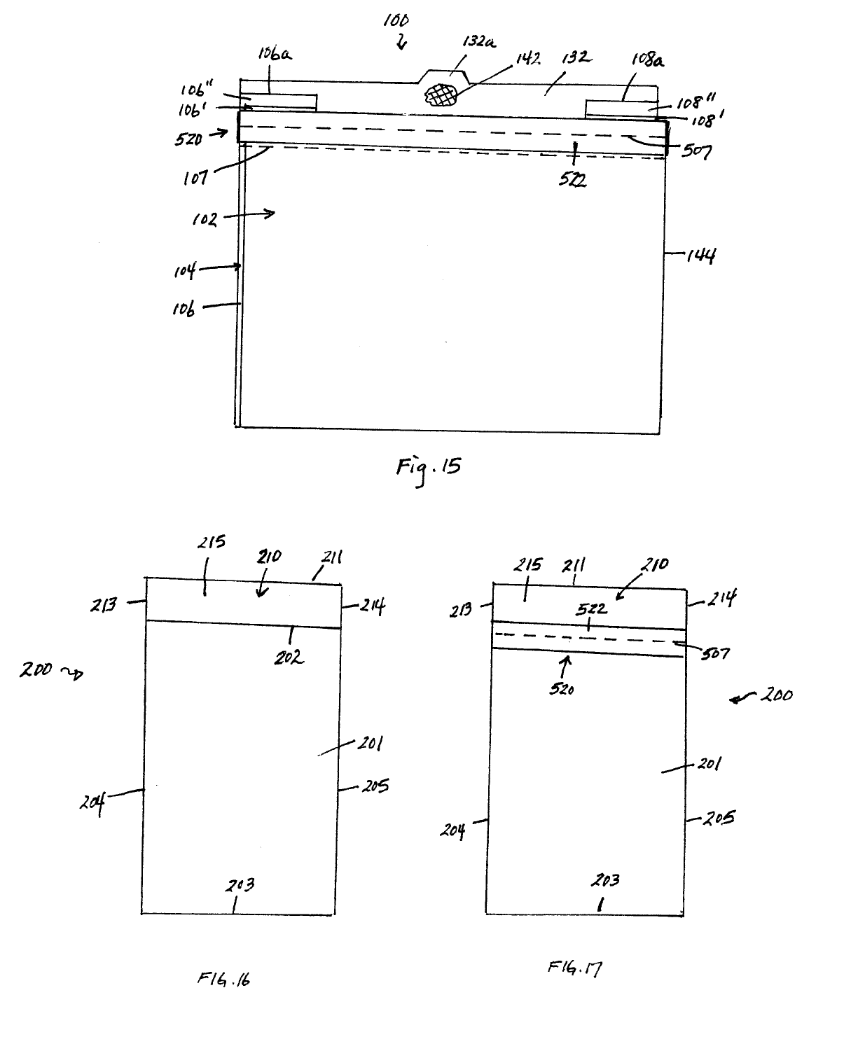

Referring now to FIG. 15, an embodiment of the bag 100 shown in FIG. 10 is shown with an easy open feature. Once again bag 100 comprises a first panel 102, a second panel 104 having hood or flap region 132 and tab portion 132a, a first side panel 106 having a first end 106a, and a second side panel 108 (not visible in FIG. 15) having a first end 108a. As shown in FIG. 15, bag 100 comprises an interior woven layer 142 (visible through cut-out) and an exterior layer 144, such as a polymeric film or paper. As shown in FIG. 15, the first side panel 106 comprises a gusset having a first portion 106′ connected by a fold to a second portion 106″. Similarly, the second side panel 108 comprises a gusset having a first portion 108′ connected by a fold to a second portion 108″. In the embodiment of the bag 100 shown in FIG. 15 the second portions 106″ and 108″ extend past the first portions 106′ and 108′, which in turn extend past the first end 102a (not visible in FIG. 15) of the first panel 102 (this configuration is also called a stepped end). Also shown is line 107, which is a reference line that demarcates a portion 105 (not visible in FIG. 15) of the first panel 102 that is separate from the remainder of the first panel 102. Also shown in FIG. 15 is easy open feature 520, comprising elongated member 522 and line 507. Easy open feature 520 is attached to the first end 102a (not visible in FIG. 15) of the first panel 102, and line 507 is aligned with the first end 102a (not visible in FIG. 15) of the first panel. Thus, in this embodiment easy open feature 520 is covering the opening defined by the first end 102a (not visible in FIG. 15) of the first panel 102 and the second panel 104.

Referring now to FIG. 16, a front view of an alternative embodiment of a bag 200 is shown. Bag 200 comprises a first panel 201 having a first end 202, a second end 203, a first side 204 and a second side 205, a second panel 210 having a first end 211, a second end 212 (not visible in FIG. 16), a first side 213, a second side 214, and a hood or flap region 215. As shown in FIG. 16, the first end 211 of the second panel 210 extends further than the first end 202 of the first panel 201. Bag 200 does not contain side panels, and is therefore a “pillowcase” style bag.

Referring now to FIG. 17, an embodiment of the bag 200 shown in FIG. 16 is shown with an easy open feature. Once again bag 200 comprises a first panel 201 having a first end 202, a second end 203, a first side 204 and a second side 205, a second panel 210 having a first end 211, a second end 212 (not visible in FIG. 16), a first side 213, a second side 214, and a hood or flap region 215. Also shown in FIG. 17 is easy open feature 520, comprising elongated member 522 and line 507. Easy open feature 520 is attached to the first end 202 (not visible in FIG. 17) of the first panel 201, and line 507 is aligned with the first end 202 (not visible in FIG. 17) of the first panel 201. Thus, in this embodiment easy open feature 520 is covering the opening defined by the first end 202 (not visible in FIG. 17) of the first panel and the second panel 210.

Those of skill in the art will realize that the various embodiments of the bags in accordance with one or more embodiments of the present disclosure may be used in a variety of applications, with a variety of contents, for example, such as for pet food, animal feed, charcoal, human foodstuffs, chemicals, seeds, resins, greens, dirt, mulch, salt, fertilizer, and nearly any bulk solids. For example, a bag made in accordance with one embodiment may comprise a woven polymer and a polymeric film laminated together with one or more easy open features as disclosed herein and when filled may contain pet food, animal feed, and other bulk solids. It is anticipated that such a bag when filled may have as its contents anywhere from about 7 or so pounds to about 100 pounds or so of such items.

This description of the exemplary embodiments is intended to be read in connection with the accompanying drawings, which are to be considered part of the entire written description. In the description, relative terms such as “lower,” “upper,” “horizontal,” “vertical,”, “above,” “below,” “up,” “down,” “top” and “bottom” as well as derivative thereof (e.g., “horizontally,” “downwardly,” “upwardly,” etc.) should be construed to refer to the orientation as then described or as disclosed in the drawing under discussion. These relative terms are for convenience of description and do not require that the apparatus be constructed or operated in a particular orientation. Terms concerning attachments, coupling and the like, such as “connected” and “interconnected,” refer to a relationship wherein structures are secured or attached to one another either directly or indirectly through intervening structures, as well as both movable or rigid attachments or relationships, unless expressly described otherwise.

Patents and patent applications referred to herein are hereby incorporated by reference in their entireties. Although the invention has been described in terms of exemplary embodiments, it is not limited thereto. Rather, the appended claims should be construed broadly, to include other variants and embodiments of the invention, which may be made by those skilled in the art without departing from the scope and range of equivalents of the invention.

What is claimed is:

1. A bag having a top, a bottom, a first side and a second side, comprising:
a) a first panel having a top, a bottom, a first side, a second side, a first surface and a second surface;
b) a first side panel having a top, a bottom, a first side, a second side, a first surface and a second surface, the first side of the first side panel attached to the second side of the first panel;
c) a second panel having a top, a bottom, a first side, a second side, a first surface and a second surface, the first side of the second panel attached to the second side of the first side panel;
d) a second side panel having a top, a bottom, a first side, a second side, a first surface and a second surface, the first side of the second side panel attached to the second side of the second panel and the second side of the second side panel attached to the first side of the first panel, the first panel, first side panel, second panel and second side panel defining a first opening proximal to the top of the front panel and a second opening proximal to the bottom of the front panel; and
e) an easy open feature attached to the first surface of the first panel proximal to the top of the first panel.

2. The bag of claim 1, wherein the top of the second panel comprises a tab.

3. The bag of claim 1, wherein the first side panel comprises a gusset comprising a top and a bottom and the second side panel comprises a gusset comprising a top and a bottom.

4. The bag of claim 1, wherein the top of the second panel extends further than the top of the first panel.

5. The bag of claim 4, wherein the top of the gusset of the first side panel and the top of the gusset of the second side panel extend further than the top of the first panel.

6. The bag of claim 5, wherein the top of the second panel extends further than the top of the gusset of the first side panel and the top of the gusset of the second side panel.

7. The bag of claim 1, wherein the easy open feature is also attached to the second surface of the second panel proximal to the top of the second panel.

8. The bag of claim 1, wherein the easy open feature covers at least a portion of the first opening.

9. The bag of claim 1, wherein the easy open feature comprises a first elongated member having a first end and a second end.

10. The bag of claim 9, wherein the first elongated member comprises a co-extruded layer.

11. The bag of claim 9, wherein the first elongated member comprises a polymeric film, an oriented polymeric film, a metalized polymeric film, or paper.

12. The bag of claim 9, wherein the easy open feature further comprises a second elongated member having a first end and a second end.

13. The bag of claim 12, wherein the first elongated member and the second elongated member comprise co-extruded layers.

14. The bag of claim 12, wherein the first elongated member and the second elongated member comprises a polymeric film, an oriented polymeric film, a metalized polymeric film, or paper.

15. The bag of claim 12, wherein the first elongated member or the second elongated member comprises a plurality of perforations.

16. The bag of claim 12, wherein the first elongated member and the second elongated member comprise a polymer.

17. The bag of claim 16, the first elongated member and the second elongated member comprise a woven polymer.

18. The bag of claim 12, wherein the first elongated member or the second elongated member comprises a sealing feature.

19. The bag of claim 18, wherein the sealing feature comprises an adhesive.

20. The bag of claim 18, wherein the first elongated member and the second elongated member further comprise a closable interlock feature.

21. The bag of claim 18, wherein the easy open feature comprises a sliding actuator between the first elongated member and the second elongated member.

22. The bag of claim 21, wherein the easy open assembly further comprises a first mechanical stop and a second mechanical stop, wherein the first mechanical stop is located proximal the first end of the first elongated member and the second elongated member and the second mechanical stop is located proximal the second end of the first elongated member and the second elongated member.

23. The bag of claim 1, wherein the first panel, first side panel, second panel and second side panel comprise a polymer.

24. The bag of claim 23, wherein the first panel, first side panel, second panel and second side panel comprise a woven polymer.

25. The bag of claim 23, wherein the first panel, first side panel, second panel or second side panel comprises a seam.

26. The bag of claim 23, further comprising a first layer of non-woven material.

27. The bag of claim 7, wherein the bottom of the bag is sealed.

28. The bag of claim 27, comprising between about 10 and about 100 pounds of solid contents.

29. The bag of claim 1, wherein the first panel, the first side panel, the second panel or the second side panel has high quality print graphics thereon.

30. A bag, comprising:
a) a first panel having a top, a bottom, a first side, a second side, a first surface and a second surface;
b) a second panel having a top, a bottom, a first side, a second side, a first surface and a second surface, the first side of the second panel attached to the second side of the first panel, and the second side of the second panel attached to the first side of the first panel, the first panel and the second panel defining a first opening proximal to the top of the front panel and a second opening proximal to the bottom of the front panel; and
c) an easy open feature attached to the first surface of the first panel proximal to the top of the first panel;

31. The bag of claim 30, wherein the top of the second panel extends further than the top of the first panel.

32. A method of making a bag, comprising:
a) preparing a bag comprising:
i) a first panel having a top, a bottom, a first side, a second side, a first surface and a second surface;
ii) a first side panel having a top, a bottom, a first side, a second side, a first surface and a second surface, the first side of the first side panel attached to the second side of the first panel;
iii) a second panel having a top, a bottom, a first side, a second side, a first surface and a second surface, the first side of the second panel attached to the second side of the first side panel; and
iv) a second side panel having a top, a bottom, a first side, a second side, a first surface and a second surface, the first side of the second side panel attached to the second side of the second panel and the second side of the second side panel attached to the first side of the first panel, and the first panel, first side panel, second panel and second side panel defining a first opening proximal to the top of the front panel and a second opening proximal to the bottom of the front panel; and
b) attaching an easy open feature to the first surface of the first panel proximal to the top of the first panel.

33. The method of claim 32, further comprising attaching the second surface of the second panel proximal to the top of the second panel to the easy open feature.

34. The method of claim 32, wherein the top of the second panel extends further than the top of the first panel.

35. The method of claim 34, wherein the bag is initially prepared with the top of the second panel and the top of the first panel extending the same distance, and thereafter a portion of the top of the first panel is folded down to contact the first surface of the first panel.

36. The method of claim 34, wherein the bag is initially prepared with the top of the second panel and the top of the first panel extending the same distance, and thereafter a portion of the top of the first panel is removed.

37. The method of claim 32, wherein the easy open feature is attached to the first surface of the first panel using an adhesive, heat, hot air, pressure, ultrasonic energy or a combination thereof.

38. The method of claim 33, wherein the easy open feature is attached to the first surface of the first panel and the second surface of the second panel simultaneously.

39. A method of making a bag, comprising:
a) preparing a bag comprising:
i) a first panel having a top, a bottom, a first side, a second side, a first surface and a second surface; and
ii) a second panel having a top, a bottom, a first side, a second side, a first surface and a second surface, the first side of the second panel attached to the second side of the first panel, and the second side of the second panel attached to the first side of the first panel, and the first panel and the second panel defining a first opening proximal to the top of the front panel and a second opening proximal to the bottom of the front panel; and
b) attaching an easy open feature to the first surface of the first panel proximal to the top of the first panel.

40. The method of claim 39, further comprising attaching the second surface of the second panel proximal to the top of the second panel to the easy open feature.

41. The method of claim 39, wherein the top of the second panel extends further than the top of the first panel.
